(19) United States
(12) Patent Application Publication
(10) Pub. No.: US 2017/0186121 A1
(43) Pub. Date: Jun. 29, 2017

(54) SYSTEM AND METHOD FOR ANALYZING THE ADEQUACY OF A HEALTHCARE NETWORK IN A GEOGRAPHIC REGION

(71) Applicant: XEROX CORPORATION, NORWALK, CT (US)

(72) Inventors: XUEJIN WEN, FAIRPORT, NY (US); JING ZHOU, PITTSFORD, NY (US); LINA FU, ONTARIO FAIRPORT, NY (US); FAMING LI, SOLON, OH (US); JENNIE ECHOLS, CUMMING, GA (US); MICHAEL D. SHEPHERD, ONTARIO, NY (US); JINHUI YAO, PITTSFORD, NY (US); DENNIS F. QUEBE, JR., AUSTIN, TX (US)

(21) Appl. No.: 14/983,170

(22) Filed: Dec. 29, 2015

(51) Int. Cl. G06Q 50/22; G06F 3/0484; G06T 11/20; G06T 11/60; G06Q 30/02; G06F 17/30

(52) U.S. Cl. CPC G06Q 50/22; G06Q 30/0205; G06F 17/30241; G06F 17/30327; G06T 11/206; G06T 11/60; G06F 3/04847

(57) ABSTRACT

A computer system configured to determine healthcare accessibility in a geographic region includes a memory storing a computer program, and a processor configured to execute the computer program. The computer program is configured to determine an expected level of care necessary for each member in the geographic region relating to a medical service type using member demographic data, aggregate the expected level of care necessary for each member to determine a total level of demand of the medical service type, and construct a ball tree representation indicating the healthcare accessibility for the medical service type on a display in real-time.

### BACKGROUND

1. Technical Field

Exemplary embodiments of the present disclosure relate to systems and methods generally related to healthcare analytics, and more particularly, to systems and methods for determining healthcare accessibility in a geographic region using a modified ball tree construction process to improve health outcomes and manage healthcare costs.

2. Discussion of Related Art

Currently, there is a trend in U.S. State Medicaid offices to transition their members from a fee-for-service payment model to a managed care payment model. The Centers for Medicare and Medicaid Services (CMS) dictates that states provide better oversight of Managed Care Organizations (MCOs). In an MCO, all healthcare providers associated with the MCO form a network to deliver healthcare services to its members. Inadequate care accessibility in a network is a major driver for many undesired member behaviors. For example, a member is more likely to visit an emergency room for non-urgent care if there is not a specialist or primary care provider near the member.

### SUMMARY

According to an exemplary embodiment of the present disclosure, a computer system configured to determine healthcare accessibility in a geographic region includes a memory storing a computer program, and a processor configured to execute the computer program. The computer program is configured to determine an expected level of care necessary for each of a plurality of members in the geographic region relating to a medical service type using member demographic data. The member demographic data includes member characteristics. The computer program is further configured to aggregate the determined expected level of care necessary for each of the plurality of members to determine a total level of demand of the medical service type in the geographic region, and construct a ball tree representation having a plurality of balls and indicating the healthcare accessibility for the medical service type in the geographic region. The computer program is further configured to construct and output the ball tree representation on a display in real-time by calculating an adjusted radius for each of the plurality of balls, receiving at least one input parameter including a threshold value from a user in real-time, calculating a location within the ball tree representation at which to place each of the plurality of balls using the adjusted radius and the threshold value, placing each of the plurality of balls in the ball tree representation using the calculated location, and completing construction of the ball tree representation upon each of the placed balls having an adjusted radius less than the threshold value. Each of the plurality of balls is a leaf node or an internal node, and each leaf node corresponds to one of the plurality of members or one of a plurality of healthcare providers of the medical service type in the geographic region.

According to an exemplary embodiment of the present disclosure, a computer system configured to determine healthcare accessibility in a geographic region includes a memory storing a computer program, and a processor configured to execute the computer program. The computer program is configured to receive member characteristics representing a plurality of members in the geographic region, select a plurality of member profiles from a predetermined library of member profiles based on a comparison of the received member characteristics with the member profiles, assign one of the selected member profiles to each of the plurality of members in the geographic region, and determine an expected level of care necessary for each of the plurality of members in the geographic region relating to a medical service type. The expected level of care necessary for the medical service type is indicated by a score included in the corresponding member profile. The computer program is further configured to aggregate the determined expected level of care necessary for each of the plurality of members to determine a total level of demand of the medical service type in the geographic region, and construct a ball tree representation having a plurality of balls and indicating the healthcare accessibility for the medical service type in the geographic region. The computer program is configured to construct and output the ball tree representation on a display in real-time by calculating an adjusted radius for each of the plurality of balls, receiving at least one input parameter including a threshold value from a user in real-time, calculating a location within the ball tree representation at which to place each of the plurality of balls using the adjusted radius and the threshold value, placing each of the plurality of balls in the ball tree representation using the calculated location, and completing construction of the ball tree representation upon each of the placed balls having an adjusted radius less than the threshold value. Each of the plurality of balls is a leaf node or an internal node, and each leaf node corresponds to one of the plurality of members or one of a plurality of healthcare providers of the medical service type in the geographic region.

### BRIEF DESCRIPTION OF THE DRAWINGS

The above and other features of the present disclosure will become more apparent by describing in detail exemplary embodiments thereof with reference to the accompanying drawings, in which:

FIG. 1 is a map showing the distribution of healthcare providers and enrolled members in an exemplary scenario.

FIG. 2 is a block diagram of a network for communication between a computer and a database, according to exemplary embodiments of the present disclosure.

FIG. 3 is a flowchart showing a method of determining healthcare accessibility in a geographic region according to an exemplary embodiment of the present disclosure.

FIG. 4 shows a ball tree constructed according to a comparative example.

FIG. 5 is a flowchart showing a method of constructing the ball tree of FIG. 4.

FIG. 6 shows a ball tree constructed according to an exemplary embodiment of the present disclosure.

FIG. 7 is a flowchart showing a method of constructing the ball tree of FIG. 6 according to an exemplary embodiment of the present disclosure.

FIG. 8 illustrates a cut-off point distinguishing the ball tree construction process of FIGS. 4 and 5 compared to the ball tree construction process of FIGS. 6 and 7.

FIG. 9 is a flowchart showing a method of constructing the ball tree representation according to an exemplary embodiment of the present disclosure.

FIG. 10 illustrates an example of a ball tree representation constructed according to exemplary embodiments of the present disclosure, as well as a corresponding binary tree representation.

FIG. 11 shows an exemplary user interface accessed by a user according to exemplary embodiments of the present disclosure.

FIG. 12 is a schematic diagram illustrating a device used to implement exemplary embodiments of the present disclosure.

FIG. 13 is a schematic diagram illustrating a system used to implement exemplary embodiments of the present disclosure.

### DETAILED DESCRIPTION

Exemplary embodiments of the present disclosure will be described more fully hereinafter with reference to the accompanying drawings. Like reference numerals may refer to like elements throughout the accompanying drawings. While the disclosure will be described hereinafter in connection with specific devices and methods thereof, it will be understood that limiting the disclosure to such specific devices and methods is not intended. On the contrary, it is intended to cover all alternatives, modifications, and equivalents as may be included within the spirit and scope of the disclosure as defined by the appended claims.

Glossary

As used herein, the following terms are understood to have the following meanings:

member: any person enrolled in a Managed Care Organization (MCO).

healthcare provider: an entity that provides a specific medical service. Examples of healthcare providers include an endocrinologist providing endocrinology services, a psychiatrist providing psychiatry services, a gastroenterologist providing gastroenterology services, a dermatologist providing dermatology services, a neurologist providing neurology services, an orthopedic doctor providing orthopedics services, an ENT providing otology services, an ophthalmologist providing ophthalmology services, an oncologist providing oncology services, etc.

medical service type: different types of healthcare provided by different types of healthcare providers. Examples of medical service types include endocrinology, psychiatry, gastroenterology, dermatology, neurology, orthopedics, otology, ophthalmology, oncology, etc.

member demographic data: includes member profiles that include member characteristics. Examples of member characteristics include age, gender, weight, ethnicity, medical condition, etc. The demand for a specific medical service type (e.g., the expected level of care necessary for a specific medical service type) varies based on member characteristics.

expected level of care necessary for a medical service type: the amount of care typically needed by a person having certain characteristics (e.g., age, gender, weight, ethnicity, medical condition, etc.) in relation to a specific medical service type.

ball tree representation: a visual representation that includes a ball tree indicating healthcare accessibility for a medical service type in a geographic region to a user. A ball tree is a geometric data structure that organizes points in a multi-dimensional space. A ball tree is a binary tree in which every node defines a ball containing a subset of points to be searched. Each internal node of the ball tree partitions the data points into two disjoint sets which are associated with different balls. While the balls themselves may intersect, each point is assigned to one or the other ball in the partition according to its distance from the ball's center. Each leaf node in the ball tree defines a ball and enumerates all data points inside that ball. Each node in the ball tree defines the smallest ball that contains all data points in its subtree. The ball tree representation may be constructed using a bottom-up implementation, in which the internal balls of the ball tree are determined bottom up from the leaf balls. According to exemplary embodiments, the ball tree is constructed using both population density information (e.g., information indicating the density of members located in a geographic region) and member characteristics information (e.g., member demographic data indicating characteristics such as age, gender, weight, ethnicity, medical condition, etc.) of the members located in the geographic region.

adjusted radius: a value calculated for each ball in a ball tree representation that is used to determine the spatial placement of the balls within the ball tree representation. The adjusted radius is larger than an actual radius of each ball in a high demand area of the geographic region, and the adjusted radius is smaller than the actual radius of each ball in a low demand area of the geographic region. The adjusted radius is a variable that may be changed by the user (e.g., via the user using various formulas to calculate the adjusted radius).

actual radius: the real straight distance from the boundary of the ball to the center of the ball.

boundary-to-boundary distance: The minimum distance between the edge of one ball to the edge of another ball.

Exemplary embodiments of the present disclosure provide systems and methods to construct a modified ball tree representation having demand-adjusted distance to be used for Managed Care Organization (MCO) network adequacy analysis. The modified ball tree representation is a hierarchical tree representation of healthcare providers and members that is generated using an efficient spatial partitioning process. The modified ball tree representation can be used by a user (e.g., a user at an MCO or at an MCO-monitoring organization such as a Medicaid office) to analyze the adequacy of a healthcare network in a specified geographic location. For convenience of explanation, exemplary embodiments of the present disclosure will be described herein as being utilized by a Medicaid office to perform healthcare network adequacy analysis. However, it is understood that exemplary embodiments may be used by various other entities (e.g., MCOs and various MCO-monitoring organizations) that have an interest in performing healthcare network adequacy analysis.

A Medicaid office may perform healthcare network adequacy analysis for a specified geographic region using a metric that reports the percentage of members that have access to a particular type of healthcare provider within a predetermined acceptable distance. The predetermined acceptable distance may vary depending on the environment type of the specified geographic region. For example, the predetermined acceptable distance may be 30 miles for an urban environment, 60 miles for a rural environment, and 90 miles for a frontier environment. A predetermined threshold value may be used as a cut-off point to determine whether access to that type of healthcare provider in the specified geographic region is considered to be adequate.

For example, a Medicaid office may decide that adequate access to an endocrinologist in a geographic region corresponds to 75% of the population in that geographic region being within the region's predetermined acceptable distance. Thus, in the current example, 75% of the population being located within a distance of 30 miles from an endocrinologist in an urban environment means that there is adequate endocrinologist access in that geographic region, 75% of the population being located within a distance of 60 miles from an endocrinologist in a rural environment means that there is adequate endocrinologist access in that geographic region, and 75% of the population being located within a distance of 90 miles from an endocrinologist in a frontier environment means that there is adequate endocrinologist access in that geographic region.

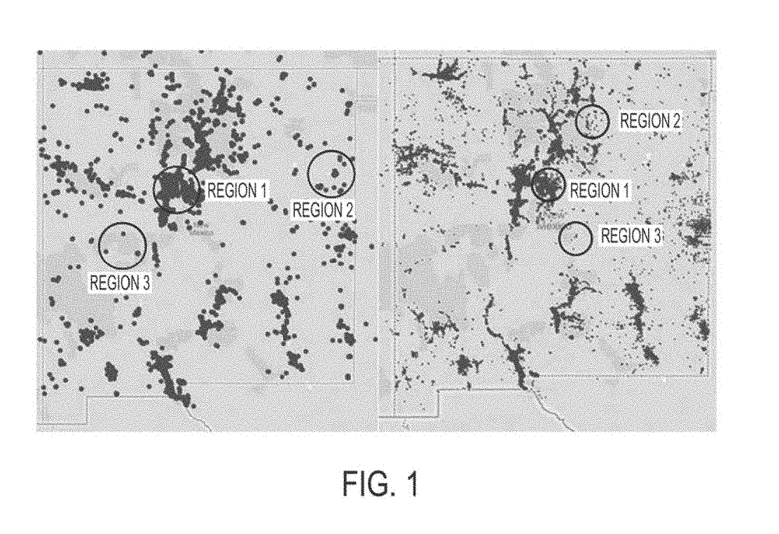

The environment type corresponding to a geographic region is often defined at a county level. However, defining the environment type at a county level may not allow for accurate network adequacy analysis, since the variation in population density within one county can sometimes be as large as the variation in population density between two different counties. That is, defining geographic regions based on discrete environment types, such as urban, rural and frontier, as described above, often does not account for the wide continuous range of population densities across geographic regions. In addition, different members having different member characteristics have different healthcare demand. For example, the healthcare demand for an endocrinologist is typically different for young people compared to elderly people. Thus, utilizing population density alone, especially when the population density is broadly defined using discrete environment types defined at a county level, typically does not provide an accurate description of the actual healthcare demand in a geographic region. For example, FIG. 1 shows the distribution of healthcare providers and enrolled members in an exemplary scenario. As shown in FIG. 1, different geographic regions 1, 2 and 3 correspond to a high, medium, and low density of healthcare providers and enrolled members.

According to exemplary embodiments of the present disclosure, a ball tree representation is constructed based on both population density information and member characteristics information. Since the ball tree representation is constructed using both population density information and member characteristics information, rather than being constructed using only population density information, the constructed ball tree representation allows a medical expert (e.g., a user at an MCO-monitoring organization (e.g., a Medicaid office), a doctor, a nurse, etc.) to determine healthcare adequacy in a geographic region in an accurate and efficient manner. The ball tree representation may be constructed on a display in real-time.

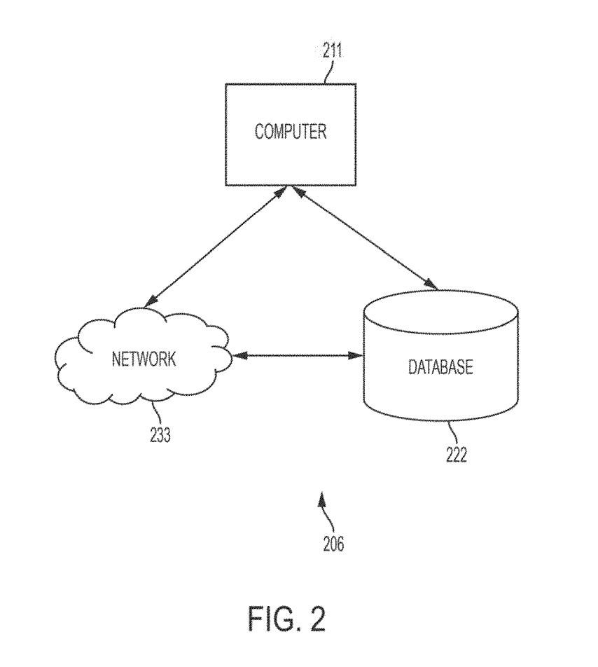

FIG. 2 shows a general overview of a network, indicated generally as 206, for communication between a computer system 211 and a database 222. The computer system 211 may include any form of processor as described in further detail below. The computer system 211 can be programmed with appropriate application software, which can be stored in a memory of the computer system 211, and which implements the methods described herein. Alternatively, the computer system 211 is a special purpose machine that is specialized for processing healthcare data and includes a dedicated processor that would not operate like a general purpose processor because the dedicated processor has application specific integrated circuits (ASICs) that are specialized for the handling of medical data processing operations, constructing a ball tree representation that indicates healthcare accessibility for a medical service type(s) in a geographic region using medical data, tracking services provided by MCOs, etc. In one example, the computer system 211 is a special purpose machine that includes a specialized processing card having unique ASICs for constructing a ball tree representation as described above, includes specialized boards having unique ASICs for input and output devices to increase the speed of network communications processing, a specialized ASIC processor that performs the logic of the methods described herein using dedicated unique hardware, logic circuits, etc.

The database 222 includes any database or any set of records or data that the computer system 211 desires to retrieve. The database 222 may be any organized collection of data operating with any type of database management system. The database 222 may contain matrices of datasets including multi-relational data elements. All libraries of data described herein may be included in the database 222, or in multiple databases 222. For example, a predetermined library of member demographic data, including member profiles, as described in detail below, may be included in the database 222 or in multiple databases 222.

The database 222 may communicate with the computer system 211 directly. Alternatively, the database 222 may communicate with the computer system 211 over the network 233. The network 233 includes a communication network for affecting communication between the computer system 211 and the database 222. For example, the network 233 may include a local area network (LAN) or a global computer network, such as the Internet.

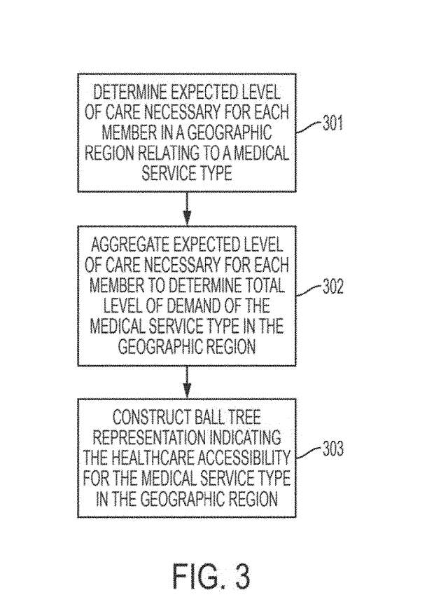

FIG. 3 is a flowchart showing a method of determining healthcare accessibility in a geographic region according to an exemplary embodiment of the present disclosure.

At block 301, the expected level of care necessary for each member in a geographic region relating to a medical service type is determined. The expected level of care necessary for each member in the geographic region is determined using member demographic data. A member refers to any person enrolled in an MCO. The medical service type refers to different types of healthcare provided by different types of healthcare providers. Examples of medical service types include endocrinology, psychiatry, gastroenterology, dermatology, neurology, orthopedics, otology, pediatrics, ophthalmology, oncology, etc. The total level of demand for each of a plurality of medical service types in a geographic region may be different. Further, each member in a geographic region has a different expected level of care necessary for each of a plurality of medical service types.

Member demographic data may include member profiles that include member characteristics. Examples of member characteristics include age, gender, weight, ethnicity, medical condition, etc. The demand for a specific medical service type (e.g., the expected level of care necessary for a specific medical service type) varies based on member characteristics. Consider Table 1, which includes exemplary member profiles A and B, each having different member characteristics:

TABLE 1

| Member Profile A | Member Profile B |
|---|---|
| Age: 10-15 | Age: 60-65 |
| Race: Caucasian | Race: Caucasian |
| Gender: Male | Gender: Female |

The expected level of care necessary for members fitting into member profiles A and B may be different for different medical service types. For example, referring to the ophthalmology medical service type, a member having the member characteristics of member profile B typically has a higher expected level of care necessary (e.g., a higher demand of care) compared to a member having the member characteristics of Member Profile A. In contrast, referring to the pediatrics medical service type, a member having the member characteristics of member profile A typically has a higher expected level of care necessary (e.g., a higher demand of care) compared to a member having the member characteristics of Member Profile B. A predetermined library of member demographic data, including member profiles, may be stored in a library of member profiles. The library may be stored in an electronic database (e.g., database 222).

Referring to block 301, in an exemplary embodiment, the process of determining the expected level of care necessary for each member in a geographic region being analyzed includes assigning a member profile to each member in the geographic region. For example, an entity such as an MCO, a hospital, a state agency, etc. may provide data including member characteristics for each member of an MCO in a geographic region. Once these member characteristics are received, this data may be compared with the member demographic data (e.g., the member profiles) stored in the predetermined library of member demographic data (e.g., a predetermined library of member profiles) to assign one of the member profiles stored in the library to each member. All members in the geographic region may then be normalized based on demand function.

At block 302, the expected level of care necessary for each member in the geographic region, as determined in block 301, is aggregated to determine a total level of demand of the medical service type in the geographic region. For example, in an exemplary embodiment, each member profile has an assigned score for different medical service types. The assigned score indicates a level of care necessary for a member having member characteristics of that member profile relating to different medical service types. For example, referring to Table 1, member profile A may have a score of 20 out of 100 for the ophthalmology medical service type, indicating that members having member characteristics of member profile A have a relatively low demand for ophthalmology medical services, and may have a score of 75 out of 100 for the pediatrics medical service type, indicating that members having member characteristics of member profile A have a relatively high demand for pediatrics medical services. Still referring to Table 1, member profile B may have a score of 85 out of 100 for the ophthalmology medical service type, indicating that members having member characteristics of member profile B have a relatively high demand for ophthalmology medical services, and may have a score of 0 out of 100 for the pediatrics medical service type, indicating that members having member characteristics of member profile B have a relatively low demand for pediatrics medical services. Once a member profile is assigned to each member in the geographic region, each member in the geographic region has a corresponding score indicating the expected level of care necessary relating to a medical service type. These scores may be aggregated to determine the total level of demand of a medical service type in the geographic region.

At block 303, a ball tree representation is constructed. A ball tree is a geometric data structure that organizes points in a multi-dimensional space. A ball tree is a binary tree in which every node defines a ball containing a subset of points to be searched. Each internal node of the ball tree partitions the data points into two disjoint sets which are associated with different balls. While the balls themselves may intersect, each point is assigned to one or the other ball in the partition according to its distance from the ball's center. Each leaf node in the ball tree defines a ball and enumerates all data points inside that ball. Each node in the ball tree defines the smallest ball that contains all data points in its subtree. The ball tree representation may be constructed using a bottom-up implementation. For example, the internal balls of the ball tree may be determined bottom up from the leaf balls.

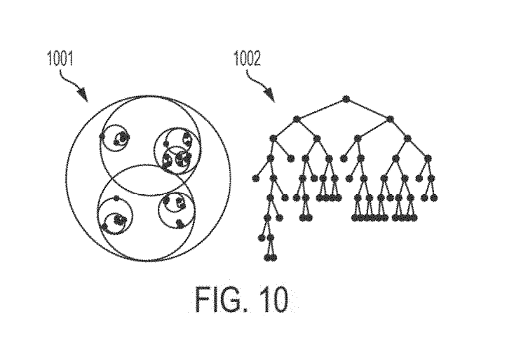

The ball tree constructed at block 303 indicates the healthcare accessibility for a medical service type in a geographic region. An example of a ball tree representation 1001 constructed according to exemplary embodiments of the present disclosure, as well as a corresponding binary tree representation 1002, are shown in FIG. 10. Each of the balls in the ball tree is a leaf node or an internal node. Each leaf node corresponds to one of the members in the geographic region or one of the healthcare providers providing the medical service type in the geographic region. That is, all members and healthcare providers are combined as leaf balls during ball tree construction. If a member and a healthcare provider are located in the same branch whose top node has a radius r, it indicates that the distance between this member and this healthcare provider is less than 2r.

The aggregated total level of demand of the medical service type in the geographic region determined at block 302 is used to adjust the distance used when constructing the ball tree. For example, in addition to the two parameters typically used during ball tree construction—the ball center and the radius—exemplary embodiments of the present disclosure utilize an additional parameter during ball tree construction. This additional parameter is referred to as an adjusted radius. The adjusted radius is larger than the actual radius of each ball in a high demand area of the geographic region, and the adjusted radius is smaller than the actual radius of each ball in a low demand area of the geographic region. During ball tree construction at block 303, the adjusted radius is utilized instead of the actual radius for volume calculation in minimization. The adjusted radius is a variable radius having a value that can be changed by the user, and the actual radius is a fixed radius having a value that cannot be changed by the user.

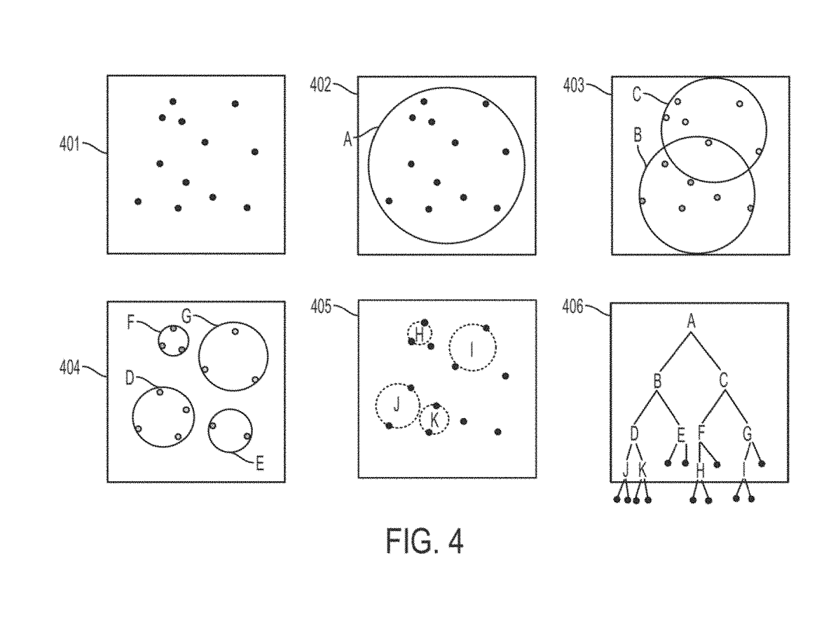

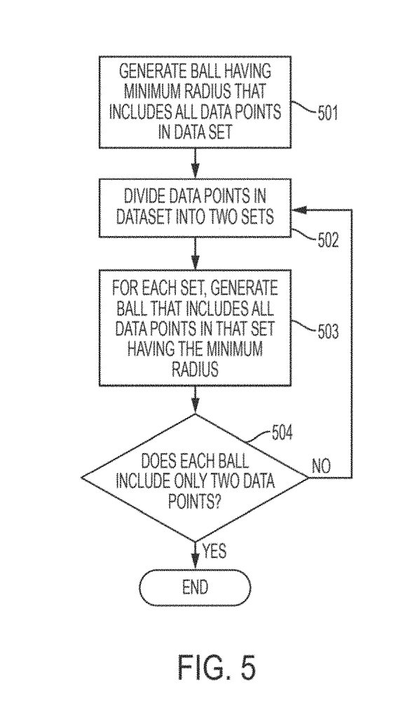

FIG. 4 shows a ball tree constructed according to a comparative example. FIG. 5 is a flowchart showing a method of constructing the ball tree of FIG. 4.

Referring to FIGS. 4 and 5, block 401 shows a dataset before construction of a ball tree. The dataset includes members and healthcare providers in a geographic region being analyzed. In operation 501, a ball having a minimum radius that includes all data points in the data set is generated. For example, in block 402, ball A including all data points in the data set is generated. Ball A corresponds to the root node. In operation 502, the data points are divided into two sets. The data points may be divided into two sets based on a variety of rules such as, for example, looking at the median point in the most spread direction. For example, in block 403, the data points in ball A are divided into balls B and C. In operation 503, for each of the sets (e.g., balls B and C in block 403), a ball is generated to include all data points in that set having the minimum radius. For example, in block 404, balls D and E are generated in ball B to include all data points in ball B having the minimum radius, and balls F and G are generated in ball C to include all data points in ball C having the minimum radius. In operation 504, it is determined whether each ball includes less than three data points. If each ball includes only one or two data points (see block 405), the ball tree construction process is completed. If any ball includes three or more data points, operations 502 and 503 are repeated until each ball includes only one or two data points. Block 406 shows an internal tree structure corresponding to the final constructed ball tree as shown in block 405.

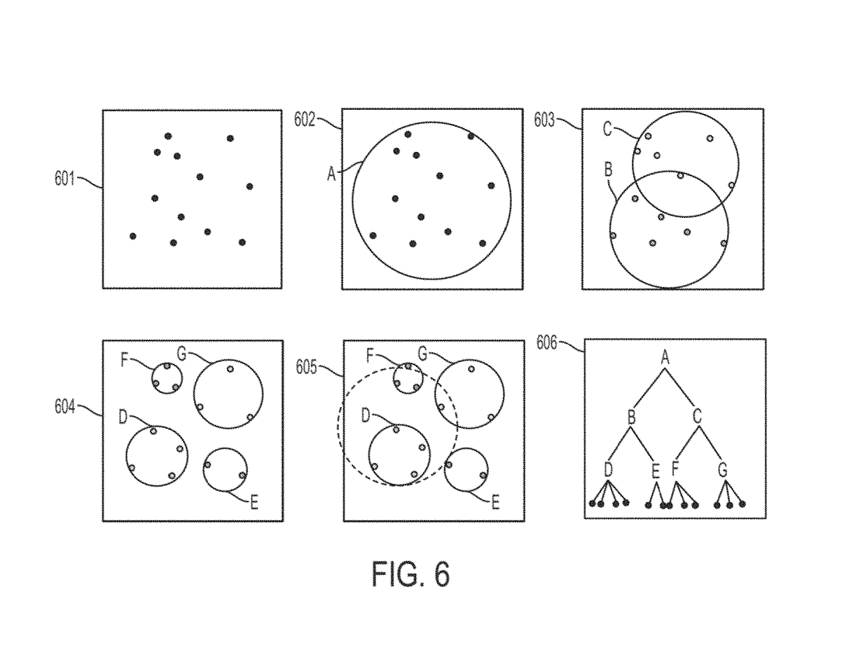

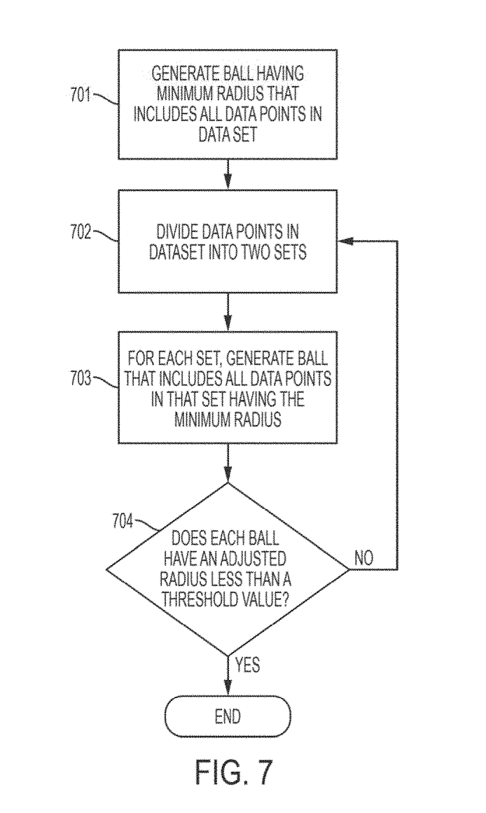

FIG. 6 shows a ball tree constructed according to an exemplary embodiment of the present disclosure. FIG. 7 is a flowchart showing a method of constructing the ball tree of FIG. 6 according to an exemplary embodiment of the present disclosure.

Referring to FIGS. 6 and 7, block 601 shows a dataset before construction of a ball tree. In operation 701, a ball having a minimum radius that includes all data points in the data set is generated. Herein, when a ball is described as being generated, it is to be understood that the ball is placed in the ball tree being constructed. For example, in block 602, ball A including all data points in the data set is generated. Ball A corresponds to the root node. In operation 702, the data points are divided into two sets. The data points may be divided into two sets based on a variety of rules such as, for example, looking at the median point in the most spread direction. For example, in block 603, the data points in ball A are divided into balls B and C. In operation 703, for each of the sets (e.g., balls B and C in block 603), a ball is generated to include all data points in that set having the minimum radius. For example, in block 604, balls D and E are generated in ball B to include all data points in ball B having the minimum radius, and balls F and G are generated in ball C to include all data points in ball C having the minimum radius. In operation 704, it is determined whether the adjusted radius of each ball is less than a threshold value.

As described above, the threshold value may be used as a cut-off point to determine whether access to a certain type of healthcare provider in the specified geographic region is considered to be adequate. The threshold value may be input by the user, and may be used to modify the distance requirements when analyzing the adequacy of the healthcare network, as described further below. Different threshold values may be used for different geographic regions. The threshold value corresponds to the required maximum distance (also referred to as the acceptable distance) adjusted by the total level of demand of the medical service type in the geographic region (as opposed to the actual radius, which depends on the local demand).

Referring again to operation 704, if each ball has an adjusted radius less than the threshold value (see block 605), the ball tree construction process is completed. If any ball has an adjusted radius that is not less than the threshold value, operations 702 and 703 are repeated until each ball has an adjusted radius less than the threshold value. Thus, according to exemplary embodiments, construction of the ball tree is terminated/completed upon each of the balls placed in the ball tree having an adjusted radius less than the threshold value. Block 606 shows an internal tree corresponding to the final constructed ball tree as shown in block 605.

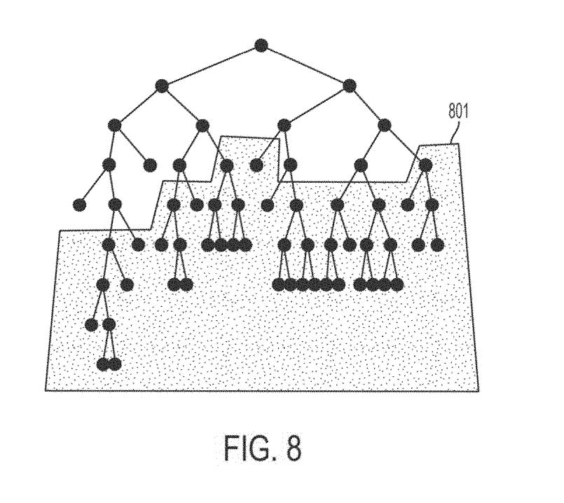

Unlike the comparative example of FIGS. 4 and 5, exemplary embodiments of the present disclosure according to FIGS. 6 and 7 include a cut-off point at which construction of the ball tree representation is stopped once each ball has an adjusted radius that is less than the threshold value. That is, rather than continuing the ball tree construction process until two or less data points remain within each ball, exemplary embodiments stop ball tree construction when each ball has an adjusted radius that is less than the threshold value. Thus, each of the lowermost parent nodes in the internal tree structure 606 according to exemplary embodiments may include more than two leaf nodes, unlike the internal tree structure 404 of the comparative example. As a result of the cut-off point, the speed of performing calculations for determining healthcare accessibility according to exemplary embodiments may be improved compared to the comparative example, since ball tree construction is not required to continue until each ball includes two or less data points. FIG. 8 illustrates a cut-off point distinguishing the ball tree construction process of FIGS. 4 and 5 compared to the ball tree construction process of FIGS. 6 and 7. In FIG. 8, the nodes included in area 801 are processed in the comparative example of FIGS. 4 and 5 (e.g., due to the requirement that ball tree construction progresses until two or less data points remain within each ball), however, these nodes are not processed in the exemplary embodiment of FIGS. 6 and 7.

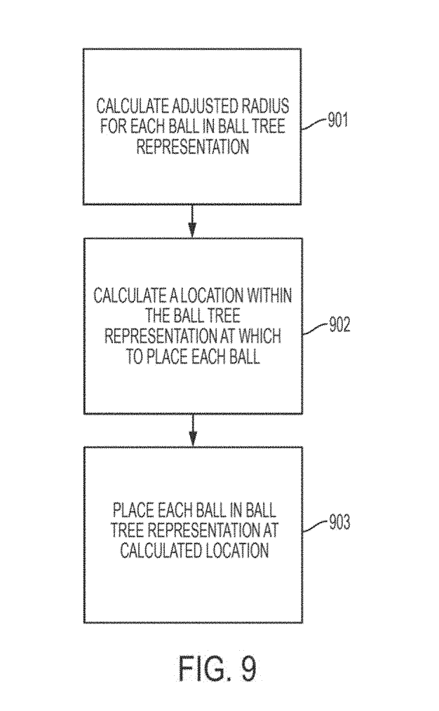

FIG. 9 is a flowchart showing a method of constructing the ball tree representation according to an exemplary embodiment of the present disclosure.

To construct the ball tree, the adjusted radius is calculated for each ball at block 901. The adjusted radius is calculated based on, for example, population density information and member characteristics information. Once the adjusted radius has been calculated for each ball, a location within the ball tree representation at which to place each ball is calculated at block 902. The location at which to place each ball is calculated using the adjusted radius without using the actual radius. Each of the balls is then placed at the corresponding calculated location at block 903.

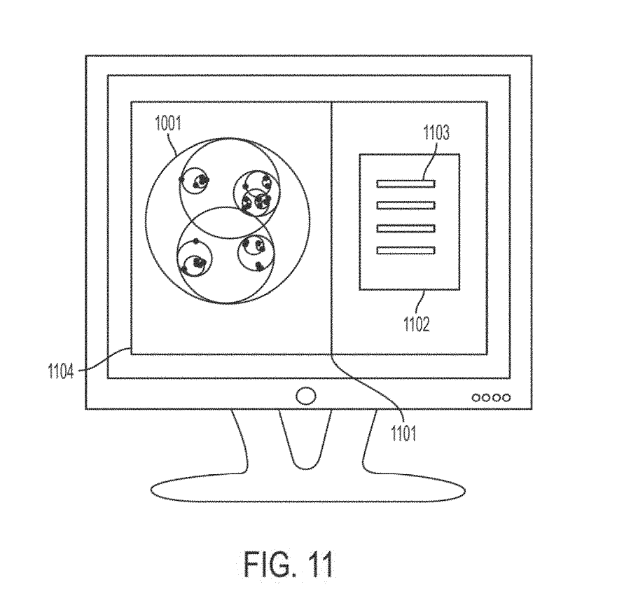

FIG. 11 shows an exemplary user interface accessed by a user according to exemplary embodiments of the present disclosure.

The ball tree representation constructed according to exemplary embodiments of the present disclosure allows a user to perform network adequacy analysis in a more accurate and efficient manner. As shown in FIG. 11, a user is presented with a user interface 1101 including an output area 1104 displaying the ball tree representation 1001 constructed according to exemplary embodiments, as well as with an input area 1102 including input fields 1103 allowing the user to provide the threshold value and input parameters in real-time that affect the construction of the ball tree representation 1001. For example, referring to the input parameters, the user may specify the type of mathematical formula (e.g., an exponential decay formula, a step function formula, etc.) to be used to calculate the adjusted radius. In addition, the user may specify member factors to be considered when calculating the adjusted radius. For example, the user may specify member factors such as population density, member risk, etc., to be used to calculate the adjusted risk.

In addition, the user may input a threshold value to modify the distance requirements used when analyzing the adequacy of the healthcare network. For example, once a threshold value, which represents a desired distance (e.g., the maximum distance/predetermined acceptable distance as described above), is entered as an input parameter by the user, the adjusted radius of each of the balls is compared to the threshold value, as described above with reference to FIGS. 6 and 7. All balls that have an adjusted radius larger than the threshold value are removed from the ball tree representation 1001, resulting in an updated ball tree representation that does not include the removed balls. Balls corresponding to members in any branch with at least one ball corresponding to a healthcare provider indicates that there is not an accessibility problem for that member. Regarding these balls, since no further searching is needed, and since this situation will typically apply to most members, exemplary embodiments of the present disclosure provide an improved computer that allows for the performance of healthcare network adequacy analysis in a more efficient manner that reduces the need to perform a large amount of computation intensive searching operations.

Regarding the remaining balls corresponding to members, a search is performed for each of these balls to determine whether the minimum distance (e.g., the boundary-to-boundary distance) between each of these balls and any nearby balls corresponding to a provider is less than the threshold value. When a ball corresponding to a provider is within the minimum distance of one of the remaining balls corresponding to a member, that provider satisfies the distance requirement relative to that member and there is not an accessibility problem for that member. In contrast, an accessibility problem exists for any of the remaining balls corresponding to members for which there is not a ball corresponding to a provider within the minimum distance. When it is determined that a ball corresponding to a member does not have adequate healthcare accessibility, an indication may be presented in the ball tree representation 1001. The indication may include, for example, a report included in the ball tree representation 101 identifying the ball(s), highlighting the ball(s) with a distinct color or animation, etc. Thus, the ball tree representation 1001 indicates to the user any area at which additional healthcare providers are needed to resolve inadequate access-to-care issues. Thus, exemplary embodiments provide systems and methods that provide an accurate indication of healthcare accessibility across a network that is not limited by a predetermined geographic restriction (e.g., a restriction based on county, as described above).

The ball tree representation 1001 is output to the output area 1104 of a display on which the user interface 1101 is displayed. As the user changes an input parameter(s) input via the input fields 1103, the ball tree representation 1001 may be updated in real-time. Updating the ball tree representation 1001 in real-time includes, for example, adding at least one ball to the plurality of balls in the displayed ball tree representation 1001 and/or removing at least one ball from the plurality of balls in the displayed ball tree representation 1001, which is described in further detail below. In an exemplary embodiment, the input fields 1103 may further be utilized to receive a recommended action from the user. The recommended action is an action that results in improving healthcare accessibility in the geographic region represented by the ball tree representation 1001. The recommended action is determined based on the displayed ball tree representation 1001. For example, once the user has viewed the ball tree representation 1001, the user may enter a recommended action that includes adding a healthcare provider at a certain location, requesting that a healthcare provider in one location move to another location, removing a healthcare provider from a certain location, etc. Once the recommended action has been entered via the input fields 1103, the recommended action is transmitted to an MCO for implementation by the MCO to improve healthcare accessibility in the geographic region. The recommended action may be transmitted either directly to the MCO or to an MCO-monitoring organization, which can then transmit the recommended action to the MCO.

The ball tree representation 1001 may be traversed to identify any child ball corresponding to a member located within a parent ball corresponding to a healthcare provider. Such a child ball represents a member that has an accepted level of healthcare provider accessibility. Similarly, a first group of child balls corresponding to members located within at least one same parent ball corresponding to a healthcare provider represents a group of members that has an accepted level of healthcare provider accessibility. A report indicating the number of balls included in the first group of balls, and thus, indicating the number of members that has an accepted level of healthcare provider accessibility, may be generated and presented to the user.

The ball tree representation 1001 may be updated in real-time as members and healthcare providers are added to and removed from the network. For example, when a new member or provider is added to the network, the ball tree representation 1001 may be updated by reconstructing branches within the ball tree representation 1001 to include the new member or provider in the manner described above. When an existing member or provider is removed from the network, if the existing member/provider is at the center of a ball, the ball may remain unchanged. In contrast, if the existing member/provider is near a boundary of the ball, the ball is reconstructed in the manner described above. In addition, the expected level of care necessary for each member in the geographic region may be re-aggregated in response to a new member entering the geographic region and in response to an existing member leaving the geographic region, and the total level of demand of the medical service type in the geographic region may be updated in real-time in response to re-aggregating the determined expected level of care.

For convenience of explanation, FIG. 11 shows the ball tree representation 1001 of FIG. 10 displayed in the output area 1104. It is to be understood that the output area 1104 may also display the ball tree according to exemplary embodiments at various stages of construction. For example, the output area 1104 may display the ball tree during the various stages of construction as shown in FIG. 6.

Regarding analyzing the adequacy of a healthcare network in a geographic region, it is noted that the amount and complexity of research and studies being performed in the medical field regarding population health adequacy of healthcare coverage are continuously increasing at a rapid pace. Some currently available systems and methods aim to provide some degree of assistance in analyzing the adequacy of a healthcare network in a geographic region. However, these systems and methods are very limited, as they are only capable of using predefined discrete distance thresholds and predefined area types, which are typically defined at a county level (i.e., a 30 mile distance threshold in an urban area, a 60 mile distance threshold in a rural area, and a 90 mile distance threshold in a frontier area), which does not account for variation in population density within a county and which does not account for the different healthcare demand of different healthcare members (i.e., the typical healthcare demand of young people compared to the typical healthcare demand of elderly people).

Exemplary embodiments of the present disclosure relate to technology used for more efficiently and accurately analyzing the adequacy of a healthcare network in a geographic region. That is, systems and methods according to exemplary embodiments of the present disclosure are inextricably tied to the technology of utilizing data stored in electronic databases to electronically construct a visual representation (e.g., a modified ball tree representation) that allows for the analysis of the adequacy of a healthcare network in a geographic region. By providing systems and methods that are necessarily rooted in the computer technology field of analyzing the adequacy of a healthcare network in a geographic region, in which such systems expand upon the existing technology that merely uses predefined discrete distance thresholds and predefined area types and that does not account for variations in healthcare demand based on member demographics (i.e., by exemplary embodiments utilizing data indicating healthcare demands based on both population density and member demographic data to adjust the distance in ball tree construction, as described above), exemplary embodiments provide a solution that overcomes shortcomings specifically arising in the realm of the technology of analyzing the adequacy of a healthcare network in a geographic region.

As would be understood by a person having ordinary skill in the art, the processes described herein cannot be performed by humans alone (or one operating with a pen and a pad of paper). Instead, such processes can only be performed by a machine. Specifically, processes such as data analysis, data security (such as encryption), electronic transmission of data over networks, etc., require the utilization of different specialized machines. For example, determining an expected level of care necessary for each member in a geographic region relating to a medical service type using member demographic data, aggregating the determined expected level of care necessary for each member to determine a total level of demand of the medical service type in the geographic region, and constructing a ball tree representation indicating the healthcare accessibility for the medical service type in the geographic region by calculating an adjusted radius, as described above, cannot be performed manually (because it would take decades or lifetimes), and are integral with the processes performed by methods herein.

Further, such machine-only processes are not mere “post-solution activity” because each process determines a set of relevant findings based on medical data. The basis of these findings leads to construction of a ball tree representation based on the calculation of an adjusted radius that is indicative of the adequacy of a healthcare network in a geographic region.

Additionally, the methods and systems herein solve many highly complex technological problems. For example, as described above, medical experts, such as those in MCO-monitoring organizations, suffer from the technological problem of not being able to efficiently and accurately analyze the adequacy of a healthcare network in a geographic region in a manner that accounts for both the wide continuous range of population densities across geographic regions and for the different levels of healthcare demand of different types of members based on member demographic data. Methods and systems herein solve this technological problem by constructing a ball tree representation indicative of healthcare network adequacy that accounts for variations in population density within a county and that also accounts for the different levels of healthcare demand of different healthcare members based on member demographic data. This results in an improved computer used to perform healthcare network adequacy analysis, which improves the efficiency of machines used by medical experts such as those in MCO-monitoring organizations, and reduces the amount of time and processing capability that an MCO-monitoring organization must utilize. By granting such benefits to MCO-monitoring organizations, the methods and systems herein reduce the amount and complexity of hardware and software needed to be purchased, installed, and maintained by MCO-monitoring organizations, thereby solving a substantial technological problem that MCO-monitoring organizations experience today. Accordingly, the technology of the user device used to implement the methods herein can be substantially simplified, thereby reducing cost, weight, size, etc., providing many substantial technological benefits to the user.

Further, the methods and systems herein are implemented by constructing a modified ball tree representation using the explicit and unique approach described above, which has not been implemented by existing computers in the technological field of analyzing the adequacy of healthcare networks in a geographic region. Thus, the methods and systems described herein do not preempt the general field of analyzing the adequacy of healthcare networks in a geographic region, since the methods and systems are limited to the sufficiently inventive concepts described herein, and are not necessary or obvious tools for analyzing the adequacy of healthcare networks in a geographic region. That is, the inventive concepts that involve determining an expected level of care necessary for each member in a geographic region relating to a medical service type using member demographic data, aggregating the determined expected level of care necessary for each member to determine a total level of demand of the medical service type in the geographic region, and constructing a ball tree representation indicating the healthcare accessibility for the medical service type in the geographic region by calculating an adjusted radius for each ball in the ball tree, as described in detail above, are not necessary or obvious tools for analyzing the adequacy of healthcare networks in a geographic region. Rather, these new and nonobvious inventive concepts provide an improved computer that allows a user to perform healthcare network adequacy analysis in a more accurate and efficient manner compared to existing computers in the technological field of healthcare network adequacy analysis.

Aspects of the present disclosure are described herein with reference to flowchart illustrations and/or block diagrams of methods, apparatuses (systems), and computer program products according to various systems and methods. It will be understood that each block of the flowchart illustrations and/or block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

According to further systems and methods herein, an article of manufacture is provided that includes a tangible computer readable medium having computer readable instructions embodied therein for performing the steps of the computer implemented methods, including the methods described above. Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein. A computer readable storage medium may be, for example, but not limited to, an electronic, magnetic, optical, electromagnetic, infrared, or semiconductor system, apparatus, or device, or any suitable combination thereof. Any of these devices may have computer readable instructions for carrying out the operations of the methods described above.

The computer program instructions may be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Furthermore, the computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

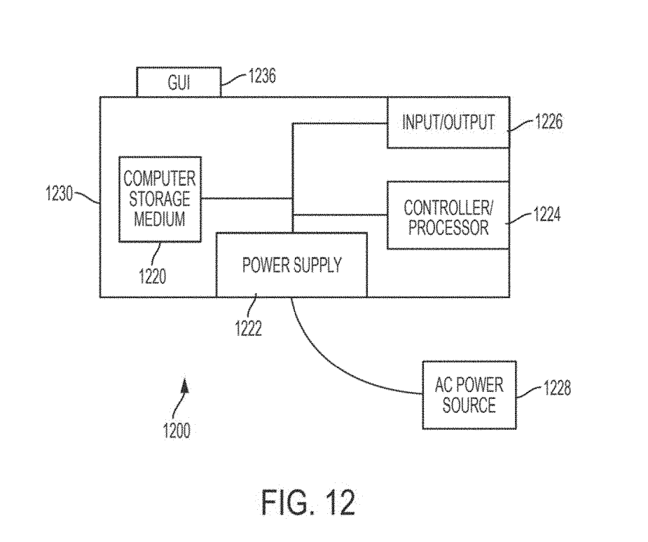

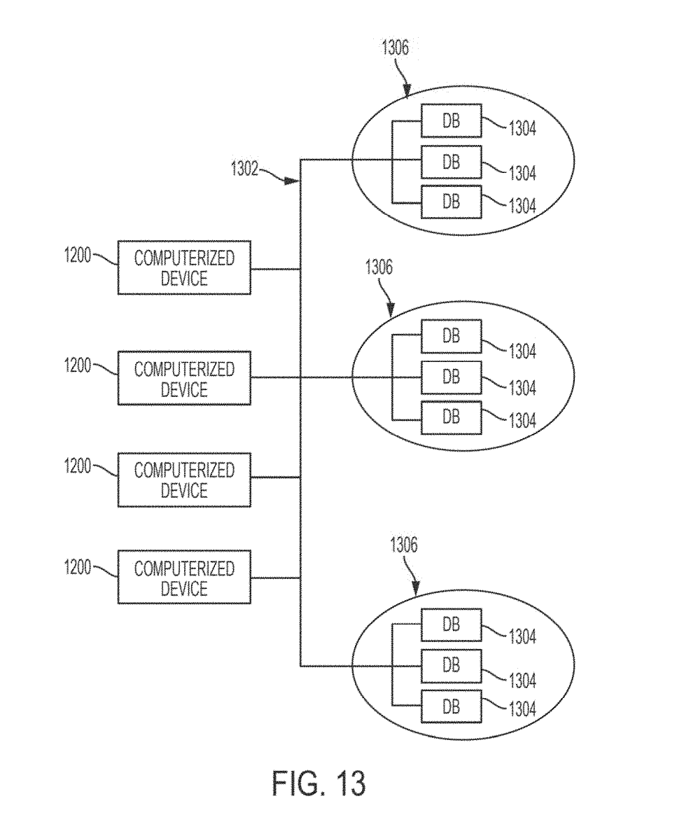

FIG. 12 illustrates a computerized device 1200, which can be used with systems and methods herein and includes, for example, a personal computer, a portable computing device, etc. The computerized device 1200 includes a controller/processor 1224 and a communications port (input/output device 1226) operatively connected to the controller/processor 1224. The controller/processor 1224 may also be connected to a computerized network 1302 external to the computerized device 1200, such as shown in FIG. 13. In addition, the computerized device 1200 can include at least one accessory functional component, such as a graphic user interface (GUI) assembly 1236 that also operates on the power supplied from the external power source 1228 (through the power supply 1222).

The input/output device 1226 is used for communications to and from the computerized device 1200. The controller/processor 1224 controls the various actions of the computerized device. A non-transitory computer storage medium 1220 (which can be optical, magnetic, capacitor based, etc.) is readable by the controller/processor 1224 and stores instructions that the controller/processor 1224 executes to allow the computerized device 1200 to perform its various functions, such as those described herein. Thus, as shown in FIG. 12, a body housing 1230 has one or more functional components that operate on power supplied from the external power source 1228, which may include an alternating current (AC) power source, to the power supply 1222. The power supply 1222 can include a power storage element (e.g., a battery) and connects to an external power source 1228. The power supply 1222 converts the external power into the type of power needed by the various components.

The computerized device 1200 may be used to provide a graphical user interface (GUI) to the user that implements the methods described herein. For example, a provided GUI may include software providing, for example, the interface described with reference to FIG. 11.

In case of implementing the systems and methods herein by software and/or firmware, a program constituting the software may be installed into a computer with dedicated hardware, from a storage medium or a network, and the computer is capable of performing various functions with various programs installed therein.

In the case where the above-described series of processing is implemented with software, the program that constitutes the software may be installed from a network such as the Internet or a storage medium such as the removable medium.

As will be appreciated by one skilled in the art, aspects of the devices and methods herein may be embodied as a system, method, or computer program product. Accordingly, aspects of the present disclosure may take the form of an entirely hardware system, an entirely software system (including firmware, resident software, micro-code, etc.), or a system combining software and hardware aspects that may all generally be referred to herein as a ‘circuit’, ‘module’, or ‘system.’ Furthermore, aspects of the present disclosure may take the form of a computer program product embodied in one or more computer readable medium(s) having computer readable program code embodied thereon.

Any combination of one or more computer readable non-transitory medium(s) may be utilized. The computer readable medium may be a computer readable signal medium or a computer readable storage medium. The non-transitory computer storage medium stores instructions, and a processor executes the instructions to perform the methods described herein.

Program code embodied on a computer readable medium may be transmitted using any appropriate medium, including, but not limited to, wireless, wireline, optical fiber cable, RF, etc., or any suitable combination thereof. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various devices and methods herein. In this regard, each block in the flowchart or block diagrams may represent a module, segment, or portion of code, which includes one or more executable instructions for implementing the specified logical function(s). It should also be noted that, in some alternative implementations, the functions noted in the block might occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

As shown in FIG. 13, exemplary systems and methods herein may include various computerized devices 1200 and databases 1304 located at various different physical locations 1306. The computerized devices 1200 and databases 1304 are in communication (operatively connected to one another) by way of a local or wide area (wired or wireless) computerized network 1302. The various electronic databases and libraries described above may be included in one or more of the databases 1304.

The terminology used herein is for the purpose of describing particular examples of the disclosed systems and methods and is not intended to be limiting of this disclosure. For example, as used herein, the singular forms ‘a’, ‘an’, and ‘the’ are intended to include the plural forms as well, unless the context clearly indicates otherwise. Additionally, as used herein, the terms ‘includes’ and ‘including’, when used in this specification, specify the presence of stated features, integers, steps, operations, elements, and/or components, but do not preclude the presence or addition of one or more other features, integers, steps, operations, elements, components, and/or groups thereof. Further, the terms ‘automated’ or ‘automatically’ mean that once a process is started (by a machine or a user), one or more machines perform the process without further input from any user.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, or a combination thereof.

What is claimed is:

1. A computer system configured to determine healthcare accessibility in a geographic region, the system comprising:
a memory storing a computer program; and
a processor configured to execute the computer program, wherein the computer program is configured to:
determine an expected level of care necessary for each of a plurality of members in the geographic region relating to a medical service type using member demographic data, wherein the member demographic data includes member characteristics;
aggregate the determined expected level of care necessary for each of the plurality of members to determine a total level of demand of the medical service type in the geographic region;
construct a ball tree representation having a plurality of balls and indicating the healthcare accessibility for the medical service type in the geographic region, wherein the computer program is configured to construct and output the ball tree representation on a display in real-time by:
calculating an adjusted radius for each of the plurality of balls;
receiving at least one input parameter including a threshold value from a user in real-time;
calculating a location within the ball tree representation at which to place each of the plurality of balls using the adjusted radius and the threshold value,
wherein each of the plurality of balls is a leaf node or an internal node, and each leaf node corresponds to one of the plurality of members or one of a plurality of healthcare providers of the medical service type in the geographic region;
placing each of the plurality of balls in the ball tree representation using the calculated location; and
completing construction of the ball tree representation upon each of the placed balls having an adjusted radius less than the threshold value.

2. The computer system of claim 1, wherein the computer program is further configured to:
update the ball tree representation on the display in real-time as the at least one input parameter received in real-time is changed by the user, wherein updating the ball tree representation comprises at least one of adding a ball to the plurality of balls and removing a ball from the plurality of balls placed in the ball tree representation;
receive a recommended action that results in improving the healthcare accessibility in the geographic region from the user based on the ball tree representation; and
transmit the recommended action to a Managed Care Organization (MCO) or an MCO-monitoring organization for implementation by the MCO.

3. The computer system of claim 1, wherein the at least one input parameter includes at least one of a mathematical formula and a member factor.

4. The computer system of claim 1, wherein the adjusted radius is larger than an actual radius of each ball in a high demand area of the geographic region, and the adjusted radius is smaller than the actual radius of each ball in a low demand area of the geographic region.

5. The computer system of claim 1, wherein the location at which to place each of the plurality of balls is calculated without using the actual radius.

6. The computer system of claim 1, wherein the computer program is further configured to:
compare the adjusted radius of each of the plurality of balls to the threshold value.

7. The computer system of claim 6, wherein the computer program is further configured to:
traverse the ball tree representation to identify a first group of child balls located within at least one same parent ball corresponding to at least one of the plurality of healthcare providers,
wherein the first group of child balls corresponds to members from among the plurality of members that have an accepted level of healthcare provider accessibility.

8. The computer system of claim 7, wherein the computer program is further configured to:
generate a report indicating a number of balls included in the first group of child balls.

9. The computer system of claim 1, wherein the medical service type is one of a plurality of medical service types, and the total level of demand for each of the plurality of medical service types in the geographic region is different.

10. The computer system of claim 1, wherein the medical service type is one of a plurality of medical service types, and each of the plurality of members has a different expected level of care necessary for each of the plurality of medical service types.

11. The computer system of claim 1, wherein the member characteristics include at least one of an age, a gender, an ethnicity and a medical condition.

12. The computer system of claim 1, wherein the computer program is further configured to:
update the constructed ball tree representation on the display in real-time, wherein updating the constructed ball tree representation comprises adding a new ball to the plurality of balls upon a corresponding new member or a corresponding new healthcare provider entering the geographic region.

13. The computer system of claim 1, wherein the computer program is further configured to:
update the constructed ball tree representation on the display in real-time, wherein updating the constructed ball tree representation comprises removing an existing ball from the plurality of balls upon a corresponding existing member or a corresponding existing healthcare provider leaving the geographic region.

14. The computer system of claim 1, wherein the computer program is further configured to:
re-aggregate the determined expected level of care necessary for each of the plurality of members in response to at least one of a new member entering the geographic region and an existing member leaving the geographic region; and
update the total demand of the medical service type in the geographic region in real-time in response to the determined expected level of care being re-aggregated.

15. The computer system of claim 1, further comprising:
determining whether a boundary-to-boundary distance between each of the balls corresponding to one of the members and any of the balls corresponding to one of the healthcare providers is less than the threshold value; and
providing an indication in the ball tree representation that each ball corresponding to one of the members that does not have a boundary-to-boundary distance less than the threshold value from any of the balls corresponding to one of the healthcare providers does not have adequate healthcare accessibility.

16. A computer system configured to determine healthcare accessibility in a geographic region, the system comprising:
a memory storing a computer program; and
a processor configured to execute the computer program, wherein the computer program is configured to:
receive member characteristics representing a plurality of members in the geographic region;
select a plurality of member profiles from a predetermined library of member profiles based on a comparison of the received member characteristics with the member profiles;
assign one of the selected member profiles to each of the plurality of members in the geographic region;
determine an expected level of care necessary for each of the plurality of members in the geographic region relating to a medical service type, wherein the expected level of care necessary for the medical service type is indicated by a score included in the corresponding member profile;
aggregate the determined expected level of care necessary for each of the plurality of members to determine a total level of demand of the medical service type in the geographic region;
construct a ball tree representation having a plurality of balls and indicating the healthcare accessibility for the medical service type in the geographic region, wherein the computer program is configured to construct and output the ball tree representation on a display in real-time by:
calculating an adjusted radius for each of the plurality of balls;
receiving at least one input parameter including a threshold value from a user in real-time;
calculating a location within the ball tree representation at which to place each of the plurality of balls using the adjusted radius and the threshold value,
wherein each of the plurality of balls is a leaf node or an internal node, and each leaf node corresponds to one of the plurality of members or one of a plurality of healthcare providers of the medical service type in the geographic region;
placing each of the plurality of balls in the ball tree representation using the calculated location; and
completing construction of the ball tree representation upon each of the placed balls having an adjusted radius less than the threshold value.

17. The computer system of claim 16, wherein the computer program is further configured to:
update the ball tree representation on the display in real-time as the at least one input parameter received in real-time is changed by the user, wherein updating the ball tree representation comprises at least one of adding a ball to the plurality of balls and removing a ball from the plurality of balls placed in the ball tree representation;
receive a recommended action that results in improving the healthcare accessibility in the geographic region from the user based on the ball tree representation; and
transmit the recommended action to a Managed Care Organization (MCO) or an MCO-monitoring organization for implementation by the MCO.

18. The computer system of claim 16, wherein the at least one input parameter includes at least one of a mathematical formula and a member factor.

19. The computer system of claim 16, wherein the adjusted radius is larger than an actual radius of each ball in a high demand area of the geographic region, and the adjusted radius is smaller than the actual radius of each ball in a low demand area of the geographic region.

20. The computer system of claim 16, further comprising:
determining whether a boundary-to-boundary distance between each of the balls corresponding to one of the members and any of the balls corresponding to one of the healthcare providers is less than the threshold value; and
providing an indication in the ball tree representation that each ball corresponding to one of the members that does not have a boundary-to-boundary distance less than the threshold value from any of the balls corresponding to one of the healthcare providers does not have adequate healthcare accessibility.
